(19) United States
(12) Patent Application Publication
(10) Pub. No.: US 2018/0126693 A1
(43) Pub. Date: May 10, 2018

(54) HEAT RADIATION MATERIAL HAVING GRAPHITE MIXTURE AND METHOD FOR MANUFACTURING THE SAME

(71) Applicant: JAPAN MATEX CO., LTD., Sennan-shi, Osaka (JP)

(72) Inventors: Katsuro Tsukamoto, Sennan-shi (JP); Hiroaki Tsukamoto, Sennan-shi (JP); Yuzo Nakamura, Sennan-shi (JP)

(73) Assignee: JAPAN MATEX CO., LTD., Sennan-shi, Osaka (JP)

(21) Appl. No.: 15/535,381

(22) PCT Filed: Jul. 28, 2016
(86) PCT No.: PCT/JP2016/072224

§ 371 Date: Jun. 13, 2017

(30) Foreign Application Priority Data
Jul. 29, 2015 (JP) 2015-150144

(51) Int. Cl. B32B 5/18; C01B 32/225; C09K 5/14; B32B 15/04; B32B 15/20; B32B 27/06; B32B 27/36

(52) U.S. Cl. CPC B32B 5/18; C01B 32/225; C09K 5/14; B32B 7/12; B32B 15/20; B32B 27/065; B32B 27/36; B32B 15/046

(57) ABSTRACT

The heat radiating material consists of a mixed graphite and sheet bodies. The mixed graphite has a uniform mixture of a foamed graphite and a filler. The foamed graphite consists of first and second foamed graphite having a particle size of 30-50 μm and 200-250 μm. The filler is one or more kinds of thermally conductive fillers selected from a group consisting of artificial graphite, boron nitride and milled pitch based carbon fiber. The first and second foamed graphite are 30-45 wt. % and 50-65 wt. % of the foamed graphite. The mixed foamed graphite is 80-95 wt. % of the entire mixed graphite. The density of the mixed graphite is 0.8-1.65 g/cm³. The mixed graphite and the sheet bodies are laminated. The heat radiating material has the thermal conductivity of 3-10 W/m·K in a thickness direction and 50-250 W/m·K in a plane direction.

### BACKGROUND OF THE INVENTION

### Field of the Invention

The present invention relates to a heat radiating material using mixed graphite. More particularly, the invention relates to a heat radiating material using a mixed graphite and sheet bodies, and having an increased thermal conductivity in a thickness direction (Z-axis direction), wherein the mixed graphite comprises a uniform mixture of two kinds of foamed graphite having different particle size and a thermally-conductive filler.

The heat radiating material using expanded graphite sheet has been conventionally used for electric products, such as a television and a personal computer.

### Description of Related Art

Japanese Unexamined Patent Application Publication No. 2015-46557 describes a radiator. More particularly, it describes a heat radiating material obtained by bending into a corrugated shape a layered product having a structure in which both sides of an expanded graphite sheet are sandwiched with metallic foils.

Japanese Patent No. 3649150 describes a radiator and a method of manufacturing thereof. More particularly, it describes a heat radiating material obtained by attaching to a metal plate an artificial graphite sheet and bending the expanded graphite sheet and the metal plate into a corrugated shape, wherein the expanded graphite sheet was obtained by graphitizing a high polymer film to exhibit thermal conductivity.

### SUMMARY OF THE INVENTION

The radiators using the conventional expanded graphite sheets in the patent documents 1 and 2 have a problem that they have low thermal conductivity in their thickness direction (Z-axis direction) but have good thermal conductivity in their plane direction (X-Y axis direction).

The first aspect of the present invention aims to solve the above described problem and provides a heat radiating material having increased thermal conductivity in thickness direction by having a uniform mixture of two kinds of foamed graphite having different particle size and one or more kinds of thermally conductive fillers selected from a group consisting of artificial graphite, boron nitride and milled pitch based carbon fiber, and also having enhanced thermal conductivity in a plane direction by sandwiching the mixture between sheet bodies.

The invention in the first embodiment is a heat radiating material, wherein the material consists of a mixed graphite and 0.1-1.65 mm thick sheet bodies, wherein the mixed graphite has a uniform mixture of a foamed graphite and a filler, wherein the foamed graphite consists of a first foamed graphite having a particle size of 30-50 μm and a second foamed graphite having a particle size of 200-250 μm, wherein the filler is one or more kinds of thermally conductive fillers selected from a group consisting of artificial graphite, boron nitride and milled pitch based carbon fiber, wherein the first foamed graphite is 30-45 wt. % of the foamed graphite, and the second foamed graphite is 50-65 wt. % of the foamed graphite, wherein the mixed foamed graphite is 80-95 wt. % of the entire mixed graphite, wherein the density of the mixed graphite is 0.8-1.65 g/cm³, wherein the mixed graphite and the sheet bodies are laminated, and wherein the heat radiating material has the thermal conductivity of 3-10 W/m·K in a thickness direction and 50-250 W/m·K in a plane direction.

The invention in the second embodiment relates to the heat radiating material according to the first embodiment, wherein the sheet bodies are polyester sheets.

The invention in the third embodiment relates to the heat radiating material according to the first embodiment, wherein the sheet bodies are aluminum foils.

The invention in the fourth embodiment relates to the heat radiating material according to the first to third embodiments, wherein the filler is one or more kinds of thermally conductive fillers selected from a group consisting of artificial graphite, boron nitride and milled pitch based carbon fiber.

The invention in the fifth embodiment is a method of manufacturing the heat radiating material according to any one of the first to fourth embodiments, comprising the steps of;

manufacturing a foamed graphite by immersing a natural graphite in acid,

manufacturing a mixed graphite by adding to the formed graphite one or more kinds of thermally conductive fillers selected from a group consisting of artificial graphite, boron nitride and milled pitch based carbon fiber,

forming the obtained mixed graphite into a sheet shape by rolling it, and

sandwiching the sheet shaped graphite between sheet bodies.

The invention in the sixth embodiment relates to the method according to the fifth embodiment, wherein the step of manufacturing a foamed graphite comprises obtaining a foamed graphite by grinding a natural graphite into particles, then immersing it in sulfuric acid, neutralizing and cleaning it, wherein the step of manufacturing a mixed graphite comprises adding a natural graphite to a furnace, foaming it at high temperature, adding into the furnace one or more kinds of thermally conductive fillers selected from a group consisting of artificial graphite, boron nitride and milled pitch based carbon fiber, and mixing them.

The second aspect of the present invention aims to solve the above described problem and provide a heat radiating material having increased thermal conductivity in a thickness direction by having a uniform mixture of two kinds of foamed graphite having different particle size and one or more kinds of thermally conductive fillers selected from a group consisting of artificial graphite, silicon carbide and milled pitch based carbon fiber, and also having enhanced thermal conductivity in a plane direction by sandwiching the uniform mixture of two kinds of foamed graphite having different particle size and the thermally conductive fillers between sheet bodies.

The invention in the seventh embodiment relates to a heat radiating material, wherein the material consists of a mixed graphite having a uniform mixture of a mixed foamed graphite and a filler, wherein the mixed foamed graphite consists of a first foamed graphite having a particle size of 30-50 μm and a second foamed graphite having a particle size of 200-250 μm, wherein the filler is one or more kinds of thermally conductive fillers selected from a group consisting of artificial graphite, silicon carbide (SiC) and milled pitch based carbon fiber, wherein the first foamed graphite is 30-45 wt. % of the mixed foamed graphite and the second foamed graphite is 50-65 wt. % of the mixed foamed graphite, wherein the mixed foamed graphite is 80-95 wt. % of the mixed graphite 100 wt. %, wherein the density of the mixed graphite is 0.8-1.65 g/cm³, wherein the mixed graphite is formed into a sheet shape and the sheet shaped graphite is sandwiched between sheet bodies, and wherein the heat radiating material has the thermal conductivity of 3-10 W/m·K in a thickness direction and 50-250 W/m·K in a plane direction.

The invention in the eighth embodiment relates to the heat radiating material according the seventh embodiment, wherein a water-based paint comprising a binder is applied to one side of the said mixed graphite formed into a sheet shape.

### Effect of the Invention

According to the invention in the first embodiment, provided is a good heat radiating material consisting of a mixed graphite having a uniform mixture of a filler and a foamed graphite, and 0.10-1.65 mm thick sheet bodies for sandwiching the mixed graphite, wherein the foamed graphite consists of a first foamed graphite having a particle size of 30-50 μm and a second foamed graphite having a particle size of 200-250 μm, wherein the filler is one or more kinds of thermally conductive fillers selected from a group consisting of artificial graphite, boron nitride and milled pitch based carbon fiber, wherein the first foamed graphite is 30-45 wt. % of the foamed graphite, and the second foamed graphite is 50-65 wt. % of the foamed graphite, wherein the foamed graphite is 80-95 wt. % of the entire mixed graphite, and wherein the heat radiating material has thermal conductivity of 3-10 W/m·K in q thickness direction and 50-250 W/m·K in a plane direction by uniformly mixing the filler.

The invention in the second embodiment can prevent graphite powders from dispersing in an apparatus which uses the heat radiating material, and prevent occurrence of electrical interference because polyester sheets can be used as sheet bodies for sandwiching the mixed graphite. According to the invention in the second embodiment, polyester sheets can be used as sheet bodies for sandwiching the mixed graphite.

The invention in the third embodiment can prevent graphite powder from dispersing in an apparatus which uses the heat radiating material, and prevent occurrence of electrical interference because aluminum foils can be used as sheet bodies for sandwiching the mixed graphite.

The invention in the fourth embodiment can enhance the improvement of thermal conductivity in a thickness direction of the heat radiating material because one more kinds of thermally conductive fillers selected from a group consisting of artificial graphite, boron nitride and milled pitch based carbon fiber can be used as a filler.

According to the invention in the fifth embodiment, provided is a method of manufacturing the heat radiating material according to any one of the first to fourth embodiments, comprising the steps of;

manufacturing a mixed graphite by adding to a foamed graphite one or more kinds of thermally conductive fillers selected from a group consisting of artificial graphite, boron nitride and milled pitch based carbon fiber,

forming the obtained mixed graphite into a sheet shape by rolling it, and

sandwiching the sheet shaped graphite between sheet bodies, so that a heat radiating material can be manufactured which has a uniform mixture of a foamed graphite and a filler, and high thermal conductivity in a thickness direction. Furthermore, the invention can prevent graphite powders from dispersing in an apparatus which uses the heat radiating material, and prevent occurrence of electrical interference.

According to the invention in the sixth embodiment, the step of manufacturing a foamed graphite comprises obtaining a foamed graphite by grinding a natural graphite into particles, then immersing it in sulfuric acid, neutralizing and cleaning it, wherein the step of manufacturing a mixed graphite comprises adding a natural graphite to a furnace, foaming it at high temperature, adding into the furnace one or more kinds of thermally conductive fillers selected from a group consisting of artificial graphite, boron nitride and milled pitch based carbon fiber, and mixing them, so that the filler can be uniformly mixed by mixing the foamed graphite and the filler in the furnace.

According to the invention in the seventh embodiment, provided is a heat radiating material consisting of a mixed graphite having an uniform mixture of a mixed foamed graphite and a filler, wherein the mixed foamed graphite consists of a first foamed graphite having a particle size of 30-50 μm and a second foamed graphite having a particle size of 200-250 μm, wherein the filler is one or more kinds of thermally conductive fillers selected from a group consisting of artificial graphite, silicon carbide (SiC) and milled pitch based carbon fiber, wherein the first foamed graphite is 30-45 wt. % of the mixed foamed graphite and the second foamed graphite is 50-65 wt. % of the mixed foamed graphite, wherein the mixed foamed graphite is 80-95 wt. % of the mixed graphite 100 wt. %, wherein the density of the mixed graphite is 0.8-1.65 g/cm³, wherein the mixed graphite is formed into sheet shape and the sheet shaped graphite is sandwiched between sheet bodies, and wherein the heat radiating material has the thermal conductivity of 3-10 W/m·K in a thickness direction and 50-250 W/m·K in a plane direction, so that the heat radiating material with high thermal conductivity in a plane direction can be provided by sandwiching the uniform mixture of a thermally conductive filler and two foamed graphite having different particle size between sheet bodies.

The invention in the eighth embodiment can achieve high thermal conductivity in thickness direction of the heat radiating material because a water-based paint comprising a binder is applied to one side of the said mixed graphite formed into a sheet shape.

The mixed graphite of the present invention relates to a uniform mixture of two foamed graphite having different particle size and a filler. The mixed graphite of the present invention is such that thermal conductivity in a thickness direction (Z-direction) is improved by including a filler between the particles of a foamed graphite, compared with the low thermal conductivity using the conventional expanded graphite sheet, and that having a mixture of the foamed graphite and the filler enables the expanded graphite to serve as a bond between filler molecules to extend the mixed graphite into a sheet shape. A plane direction means a direction parallel to a sheet plane and a thickness direction means a direction perpendicular to the sheet plane. A foamed graphite is manufactured by grinding a natural graphite into particles, then immersing it in sulfuric acid, neutralizing and cleaning it, and heating and foaming it at high temperature. The foamed graphite has increased thermal conductivity in a thickness direction, compared with a mixture of a foamed graphite having the same particle size and a filler, because the foamed graphite consists of two kinds of foamed graphite comprising a first foamed graphite having a particle size of 30-50 μm and a second foamed graphite having a particle size of 200-250 μm. For the ratio of the foamed graphite constituted from two kinds of foamed graphite having different sizes, the first foamed graphite is 30-45 wt. % of the foamed graphite, and the second foamed graphite is 50-65 wt. % of the foamed graphite. The heating and foaming at high temperature may be performed by, for example, cutting off and heating the air at high temperature from 1000 to 2000° C. A furnace such a graphitization furnace is preferably used to process a natural graphite (graphite) at high temperature. The filler of the present invention is a filling material with high thermal conductivity, and includes, but not limited to, hexagonal boron nitride and a carbon compound, for example, milled pitch based carbon fiber, boron nitride, and artificial graphite. The artificial graphite of the present invention includes the one including coke and pitch as its main ingredients and the one obtained by heating and burning polyimide film in inert gas for graphitization. For example, the mixed graphite is manufactured by mixing a filler with a foamed graphite made by processing the natural graphite as shown above. The mixed graphite may also be manufactured by mixing a filler with an acid-treated graphite powder and by heating and foaming it at high temperature, wherein the acid-treated graphite powder is obtained by grinding natural graphite into particles, then immersing it in sulfuric acid, neutralizing and cleaning it. When an artificial graphite is used as a filler, the artificial graphite is not foamed even if the acid-treated graphite powder is mixed with the filler, and heated and foamed at high temperature. Methods of mixing the foamed graphite and the filler and mixing the acid-treated graphite powder and the filler include, but not limited to, a method of rotating and mixing them with an agitator. A mixing ratio of the foamed graphite and the filler is preferably 8:2. Density of the mixed graphite is 0.8 to 1.65 g/cm³, and in particular, preferably 1.50 g/cm³.

There may be a problem that the foamed graphite itself has low strength and thus its graphite powders tend to disperse inside the apparatus to be used, possibly causing electric interference. This problem can be improved by sandwiching a graphite layer between two sheets. Resin sheets such as polyethylene terephthalate (PET) and metallic foils, preferably aluminum foils, may be used as sheet bodies. A thickness of the sheet body is 0.25-1.65 mm. When the mixed graphite is sandwiched by the sheet bodies, it may be spread on the pre-laid sheet body and the other sheet body may be attached thereto, or it may be rolled with sheet bodies attached with an adhesive by a roller, or it may be manufactured by sandwiching the pre-rolled mixed graphite with a roller between two sheets.

### BRIEF DESCRIPTION OF THE DRAWINGS

FIG. 1A is a cross-sectional view showing a method of manufacturing a heat radiating material according to the examples of the present invention.

FIG. 1B is a cross-sectional view showing another method of manufacturing a heat radiating material according to the examples of the present invention.

### DETAILED DESCRIPTION OF THE INVENTION

### EXAMPLE 1

Although the present invention describes an example of a method of manufacturing a heat radiating material, it is not limited to these examples.

### 1. Method of Manufacturing Foamed Graphite

A natural graphite is ground into particles, and then immersed in a sulfuric acid, neutralized and cleaned, and also heated to a high temperature to be foamed, to manufacture a foamed graphite.

### 2. Method of Manufacturing Mixed Graphite

2% of GRANOC milled fiber made by Nippon Graphite Fiber Co., Ltd. (HC-600-15M, fiber length: 150 μm) is added to the foamed graphite as a filler, stirred to be uniformly mixed while shaken in a plastic bag, and put into a metallic mold with 105 mm squares to mold a mixed graphite under a molding pressure of 7500N (about 68 kg/cm² of surface pressure).

### 3. Method of Manufacturing Heat Radiating Material

11 μm of aluminum foil pre-processed with the adhesive is placed, the molded mixed graphite is put thereon, and an additional aluminum foil is overlaid on the mixed graphite, which is then press molded to manufacture a 250 μm thick layered product.

### EXAMPLE 2

The same methods are implemented as those in the Example 1 except that 5% of GRANOC milled fiber made by Nippon Graphite Fiber Co., Ltd. (HC-600-15M, fiber length: 150 μm) is mixed as a filler and that the thickness of the layered product is set to be 200 μm.

### EXAMPLE 3

The same methods are implemented as those in the Example 1 except that 5% of charged boron nitride made by Denka Company Limited (GP particle size: 8.2 μm) is mixed as a filler and that the thickness of the layered product is set to be 220 μm.

### EXAMPLE 4

The same methods are implemented as those in the Example 1 except that 10% of charged boron nitride made by Denka Company Limited (GP particle size: 8.2 μm) is mixed as a filler and that the thickness of the layered product is set to be 330 μm.

### EXAMPLE 5

The same methods are implemented as those in the Example 1 except that 10% of SEC fine powder SGL-25 with a particle size of 20 μm made by SEC CARBON, LIMITED is mixed as a filler and that the thickness of the layered product is set to be 250 μm.

### EXAMPLE 6

The same methods are implemented as those in the Example 1 except that 20% of SEC fine powder SGL-25 with a particle size of 20 μm made by SEC CARBON, LIMITED is mixed as a filler and that the thickness of the layered product is set to be 320 μm.

### EXAMPLE 7

The same methods are implemented as those in the Example 1 except that 10% of SEC fine powder SGL-50 with a particle size of 50 μm made by SEC CARBON, LIMITED is mixed as a filler and that the thickness of the layered product is set to be 215 μm.

### EXAMPLE 8

The same methods are implemented as those in the Example 1 except that 20% of SEC fine powder SGL-50 with a particle size of 50 μm made by SEC CARBON, LIMITED is mixed as a filler and that the thickness of the layered product is set to be 410 μm.

### EXAMPLE 9

### 1. Method of Manufacturing Mixed Graphite

An acid-treated graphite powder, obtained by immersing a natural graphite powder in a sulfuric acid and then neutralizing and cleaning, is mixed with a 20% of SEC fine powder SGL-50 with a particle size of 50 μm made by SEC CARBON, LIMITED as an artificial graphite of a filler, and heated to a high temperature to be foamed uniformly, and then put into a metallic mold with 105 mm squares to mold a mixed graphite under a molding pressure of 7500N (about 68 kg/cm² of surface pressure).

### 2. Method of Manufacturing Heat Radiating Material

A 30 μm of PET sheet pre-processed with the adhesive is placed, the molded mixed graphite is put thereon, and additional 30 μm of PET sheet is overlaid on the mixed graphite, which is then press molded to manufacture a 1,560 μm thick layered product.

### EXAMPLE 10

The same methods are implemented as those in the Example 9 except that 50 μm of aluminum foil is used as a heat radiating material and that the thickness of the layered product is set to be 1,600 μm.

### COMPARATIVE EXAMPLES

The Comparative Example 1 uses a 157 μm thick layered product obtained by lamination of an expanded graphite and PET sheet. The Comparative Example 2 uses a 300 μm thick layered product obtained by lamination of an expanded graphite and PET sheet. The Comparative Example 3 uses only a foamed graphite.

Each of 5 mm square of the above-mentioned Examples 1 to 10 and Comparative Examples 1 to 3 was used as a sample, and each thermal diffusivity and thermal conductivity in a thickness direction of the heat radiating material was measured and compared by ai-Phase Mobile 1u (made by ai-Phase Co., Ltd.). Table (average value of N=3)

| | Thermal | Thermal |
|---|---|---|
| Measurement | Diffusivity | Conductivity |
| Documentation | (E−07 m²/s) | (W/m · K) |
| Example 1 | 41.8 | 3.6 |
| Example 2 | 52.0 | 4.4 |
| Example 3 | 35.6 | 3.0 |
| Example 4 | 75.4 | 6.4 |
| Example 5 | 61.6 | 5.2 |
| Example 6 | 98.5 | 8.4 |
| Example 7 | 48.5 | 4.1 |
| Example 8 | 120.0 | 10.3 |
| Example 9 | 128.0 | 10.9 |
| Example 10 | 141.7 | 12.1 |
| Comparative Example 1 | 6.07 | 0.5 |
| Comparative Example 2 | 14.1 | 1.0 |
| Comparative Example 3 | 55.8 | 4.8 |

As shown in the table, the results show higher thermal conductivity of 3.6 W/m·K in the Example 1 and 4.4 W/m·K in the Example 2 compared with that of 0.5 W/m·K in the conventional Comparative Example 1 and that of 1.0 W/m·K in the conventional Comparative Example 2. The Comparative Example 3 has high thermal conductivity, but it cannot be used for a heat radiating material in practice since the foamed graphite powders inside the apparatus used and cause electric interference. Also, from the result of 4.4 W/m·K in the Example 2 compared with 3.6 W/m·K in the Example 1, the more filler is mixed, the higher the thermal conductivity becomes. Further, the results show much higher thermal conductivity of 10.9 W/m·K and 12.1 W/m·K in the Examples 9 and 10, respectively, where an acid-treated graphite powder of a natural graphite powder is mixed with an artificial graphite and then foamed, compared with the Comparative Examples. This may be because adhesiveness of the foamed graphite and the artificial graphite was increased by mixed the artificial graphite and then foaming it. Moreover, the heat radiating material of this invention has higher thermal diffusivity compared with the conventional one. The results show higher values of 41.8 E−07 m²/s in the Example 1 and 52.8 E−07 m²/s in the Example 2 compared with that of 6.07 E−07 m²/s in the Comparative Example 1 and that of 14.1 E−07 m²/s in the Comparative Example 2. And the results show much higher thermal diffusivity of 128.0 E−07 m²/s and 141.7 E−07 m²/s in the Examples 9 and 10, respectively, compared with the Comparative Examples.

### EXAMPLE 11

GRANOC milled fiber made by Nippon Graphite Fiber Co., Ltd. (HC-600-15M, fiber length: 150 μm, thermal conductivity: 600 W/m·K, density: 2.22) was used as a filler and mixed and stirred in a ratio of the expanded graphite:the filler=12 g:3 g to create a press sheet. A disk of 1 mm thickness and 110 mm diameter was created from the press sheet and sampled for three samples from the three parts of the disk, i.e., a sample of about 0.97 mm thickness (sample 1), a sample of about 1.11 mm thickness (sample 2), and a sample of about 1.12 mm thickness (sample 3), to measure thermal conductivity in a thickness direction. Thermal conductivity a (W/m·K) was measured 5 times at each three part of the samples 1 to 3, and thermal diffusivity κ (10⁻⁶ m²/s) was calculated with density ρ of 1.58 g/cm³ and specific heat Cp of 1.25 J/(g·K). Additionally, an average thermal conductivity at each part was calculated from the thermal conductivity measured 5 times.

The results in sample 1 are as follows and the average thermal conductivity (W/m·K) is 17.73.

| | Thermal Diffusivity | Thermal Conductivity |
|---|---|---|
| | (10⁻⁶ m²/s) | (W/m · K) |
| 1 | 9.1 | 17.97 |
| 2 | 9.57 | 18.90 |
| 3 | 8.85 | 17.48 |
| 4 | 9.65 | 19.06 |
| 5 | 7.71 | 15.23 |

The results in sample 2 are as follows and the average thermal conductivity (W/m·K) is 15.25.

| | Thermal Diffusivity | Thermal Conductivity |
|---|---|---|
| | (10⁻⁶ m²/s) | (W/m · K) |
| 1 | 6.72 | 13.27 |
| 2 | 8.31 | 16.41 |
| 3 | 8.83 | 17.44 |
| 4 | 7.9 | 15.60 |
| 5 | 6.86 | 13.55 |

The results in sample 3 are as follows and the average thermal conductivity (W/m·K) is 19.01.

| | Thermal Diffusivity | Thermal Conductivity |
|---|---|---|
| | (10⁻⁶ m²/s) | (W/m · K) |
| 1 | 10.2 | 20.15 |
| 2 | 9.27 | 18.31 |
| 3 | 9.34 | 18.45 |
| 4 | 9.44 | 18.64 |
| 5 | 9.87 | 19.49 |

The average of the thermal conductivity at three parts of samples 1 to 3 was calculated in order to calculate thermal conductivity of the disk created in Example 11. The average was 17.33 W/m·K. Thermal conductivity of an expanded graphite alone in a thickness direction was measured. The result showed the value of 5 W/m·K to 7 W/m·K. From the above, it can be said that the present invention in a thickness direction has a higher thermal conductivity and demonstrates higher performance compared with the expanded graphite alone in a thickness direction.

### EXAMPLE 12

Another method of manufacturing a foamed graphite is described as follows:

### 1. Method of Manufacturing Foamed Graphite

A natural graphite is ground into particles, and then immersed in a sulfuric acid, neutralized and cleaned, and then put in a furnace, exposed to the temperature of 1,350° C., and foamed to manufacture a foamed graphite.

### 2. Method of Manufacturing Mixed Graphite

To the foamed graphite in the furnace, added 15% of artificial graphite as a filler and stirred to mold a mixed graphite.

### 3. Method of Manufacturing Heat Radiating Material

The mixed graphite is discharged from a discharge port of the furnace and passed between a plurality of rollers arranged on the upper and lower surfaces of the mixed graphite to roll the above-mentioned mixed graphite. The rolled mixed graphite was sandwiched with two sheets of aluminum foil to manufacture a 1.5 μm thick layered product.

### EXAMPLE 13

Yet another method of manufacturing a foamed graphite is described as follows:

### 1. Method of Manufacturing Foamed Graphite

A natural graphite is ground into particles, and then immersed in a sulfuric acid, neutralized and cleaned, and then put in a furnace, exposed to the temperature of 1,350° C., and foamed to manufacture a foamed graphite.

### 2. Method of Manufacturing Mixed Graphite

To the foamed graphite in the furnace, added 20% of artificial graphite as a filler and stirred to mold a mixed graphite.

### 3. Method of Manufacturing Heat Radiating Material

The mixed graphite is discharged from a discharge port of the furnace and passed between a plurality of rollers arranged on the upper and lower surfaces of the mixed graphite to roll the above-mentioned mixed graphite. The rolled mixed graphite was sandwiched with two sheets of aluminum foil to manufacture a 1.5 μm thick layered product.

### EXAMPLE 14

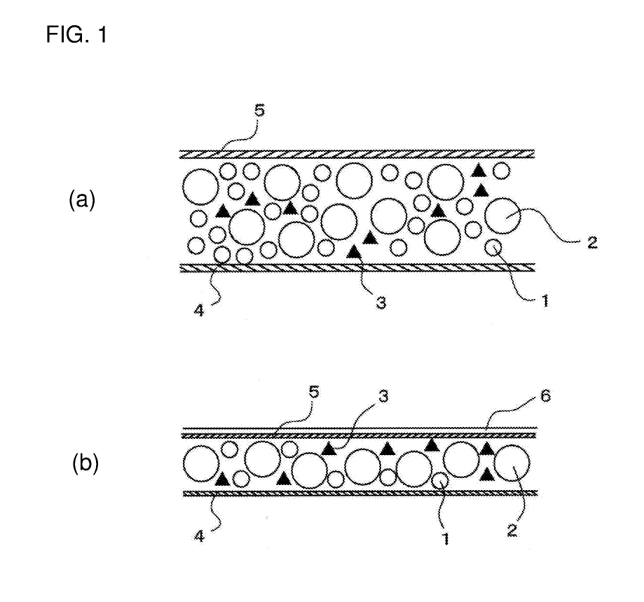

A heat radiating material according to the example corresponding to the seventh embodiment of the present invention was manufactured (See FIG. 1A). An artificial graphite filler (3) was mixed with 40 wt. % of a first foamed graphite (1) having a particle size of 30 μm to 50 μm and 60 wt. % of a second foamed graphite (2) having a particle size of 200 μm to 250 μm to give a mixed graphite. The mixing ratio of the artificial graphite filler (3) to the first and second foamed graphites (1, 2) was 20% to 80%. Subsequently, a 0.02 mm of aluminum foil (4, 5) pre-processed with the adhesive was placed, the molded mixed graphite (1, 2, 3) was put thereon, and an additional aluminum foil (4, 5) was overlaid on the mixed graphite (see FIG. 1A), and then they were press molded to manufacture a 0.5 mm thick layered product. The radiation rate was 45.6%, the thermal conductivity in a plane direction (x-y axis direction) was 284.6 W/m·K, and the thermal conductivity in a thickness direction (z-axis direction) was 5.44 W/m·K.

### EXAMPLE 15

A heat radiating material according to the example corresponding to the eighth embodiment of the present invention was manufactured (See FIG. 1B). A green silicon carbide filler (3) was mixed with 40 wt. % of a first foamed graphite (1) having a particle size of 30 μm to 50 μm and 60 wt. % of a second foamed graphite (2) having a particle size of 200 μm to 250 μm to give a mixed graphite. The mixing ratio of the green silicon carbide filler (3) to the first and second foamed graphites (1, 2) was 20% to 80%. Subsequently, a 0.02 mm of aluminum foil (4, 5) pre-processed with the adhesive was placed, the molded mixed graphite (1, 2, 3) was put thereon, and an additional aluminum foil (4, 5) was overlaid on the mixed graphite (see FIG. 1B), and then they were press molded to manufacture a 0.5 mm thick layered product. Furthermore, a water-based paint (6) was applied to the aluminum foil (5) to give a heat radiating material. A paint (a water-based paint) for screen printing manufactured by Seiko advance Ltd. was used as a water-based paint. Components of this paint (comprising binder) are hexane, ethylene glycol, carbon black, acrylic resin, and solvent. The radiation rate was 49.2%, the thermal conductivity in a plane direction (x-y axis direction) was 218.2 W/m·K, and the thermal conductivity in a thickness direction (z-axis direction) was 5.38 W/m·K.

### Comparative Example 4

A heat radiating material according to the comparative example 4 was manufactured. A graphite of 40 wt. % of a first foamed graphite having a particle size of 30 μm to 50 μm and 60 wt. % of a second foamed graphite having a particle size of 200 μm to 250 μm was obtained. Subsequently, a 0.02 mm of aluminum foil pre-processed with the adhesive was placed, the molded mixed graphite was put thereon, and an additional aluminum foil was overlaid on the mixed graphite, and then they were press molded to manufacture a 0.5 mm thick layered product. The radiation rate was 37.7%, the thermal conductivity in a plane direction (x-y axis direction) was 267.0 W/m·K, and the thermal conductivity in a thickness direction (z-axis direction) was 4.64 W/m·K. Comparing the heat radiating materials in the examples 14 and 15 with the heat radiating material in the comparative example 4, the thermal conductivity of the examples 14 and 15 both in a plane direction (x-y axis direction) and a thickness direction (z-axis direction) was higher than that of the heat radiating material in the comparative example 4.

### INDUSTRIAL APPLICABILITY

Since the mixed graphite of the present invention has high thermal conductivity in a Z-axis direction and a X-Y axis direction, it may be used not only as a heat radiating material but also as a thermal conductor depending on thinness of an apparatus used. For example, a mixed graphite which is sandwiched by resin sheet bodies or metallic foils having high thermal conductivity in a plane direction can be used for a thick apparatus such as a computer, since it is arranged between an overlapped fin and CPU. And a mixed graphite which is laminated with metallic foils, especially aluminum foils, having high thermal conductivity in a X-Y axis direction can be used for a thin apparatus such as a flat TV, since it is used as a heat pipe linking the CPU and the fin arranged next to each other.

### EXPLANATION OF REFERENCE NUMBER

1 First Foamed Graphite
2 Second Foamed Graphite
3 Filler
4 and 5 Aluminum foil
6 Water-based paint

1. A heat radiating material consisting of a mixed graphite and 0.1-1.65 mm thick sheet bodies,
wherein the mixed graphite has a uniform mixture of a foamed graphite and a filler, wherein the foamed graphite consists of a first foamed graphite having a particle size of 30-50 μm and a second foamed graphite having a particle size of 200-250 μm,
wherein the filler is one or more kinds of thermally conductive fillers selected from a group consisting of artificial graphite, boron nitride and milled pitch based carbon fiber,
wherein the first foamed graphite is 30-45 wt. % of the foamed graphite, and the second foamed graphite is 50-65 wt. % of the foamed graphite,
wherein the mixed foamed graphite is 80-95 wt. % of the entire mixed graphite,
wherein the density of the mixed graphite is 0.8-1.65 g/cm³,
wherein the mixed graphite and the sheet bodies are laminated, and
wherein the heat radiating material has the thermal conductivity of 3-10 W/m·K in a thickness direction and 50-250 W/m·K in a plane direction.

2. The heat radiating material according to claim 1, wherein the sheet bodies are polyester sheets.

3. The heat radiating material according to claim 1, wherein the sheet bodies are aluminum foils.

4. The heat radiating material according to claim 1, wherein the filler is one or more kinds of thermally conductive fillers selected from a group consisting of artificial graphine, boron nitride and milled pitch based carbon fiber.

5. A method of manufacturing the heat radiating material according to claim 1, comprising the steps of;
manufacturing a foamed graphite by immersing a natural graphite in acid,
manufacturing a mixed graphite by adding to the formed graphite one or more kinds of thermally conductive fillers selected from a group consisting of artificial graphite, boron nitride and milled pitch based carbon fiber,
forming the obtained mixed graphite into a sheet shape by rolling it, and
sandwiching the sheet shaped graphite between sheet bodies.

6. The method according to claim 5, wherein the step of manufacturing a foamed graphite comprises obtaining a foamed graphite by grinding a natural graphite into particles, then immersing it in sulfuric acid, neutralizing and cleaning it, wherein the step of manufacturing a mixed graphite comprises adding a natural graphite to a furnace, foaming it at high temperature, adding into the furnace one or more kinds of thermally conductive fillers selected from a group consisting of artificial graphite, boron nitride and milled pitch based carbon fiber, and mixing them.

7. A heat radiating material consisting of a mixed graphite having a uniform mixture of a mixed foamed graphite and a filler,
wherein the mixed foamed graphite consists of a first foamed graphite having a particle size of 30-50 μm and a second foamed graphite having a particle size of 200-250 μm,
wherein the filler is one or more kinds of thermally conductive fillers selected from a group consisting of artificial graphite, silicon carbide (SiC) and milled pitch based carbon fiber,
wherein the first foamed graphite is 30-45 wt. % of the mixed foamed graphite and the second foamed graphite is 50-65 wt. % of the mixed foamed graphite,
wherein the mixed foamed graphite is 80-95 wt. % of the mixed graphite 100 wt. %,
wherein the density of the mixed graphite is 0.8-1.65 g/cm³,
wherein the mixed graphite is formed into a sheet shape and the sheet shaped graphite is sandwiched between sheet bodies, and
wherein the heat radiating material has the thermal conductivity of 3-10 W/m·K in a thickness direction and 50-250 W/m·K in a plane direction.

8. The heat radiating material according to claim 7, wherein a water-based paint comprising a binder is applied to one side of the said mixed graphite formed into a sheet shape.

9. The heat radiating material according to claim 2, wherein the filler is one or more kinds of thermally conductive fillers selected from a group consisting of artificial graphite, boron nitride and milled pitch based carbon fiber.

10. The heat radiating material according to claim 3, wherein the filler is one or more kinds of thermally conductive fillers selected from a group consisting of artificial graphite, boron nitride and milled pitch based carbon fiber.

11. A method of manufacturing the heat radiating material according to claim 2, comprising the steps of;
manufacturing a foamed graphite by immersing a natural graphite in acid,
manufacturing a mixed graphite by adding to the formed graphite one or more kinds of thermally conductive fillers selected from a group consisting of artificial graphite, boron nitride and milled pitch based carbon fiber,
forming the obtained mixed graphite into a sheet shape by rolling it, and sandwiching the sheet shaped graphite between sheet bodies.

12. A method of manufacturing the heat radiating material according to claim 3, comprising the steps of;
manufacturing a foamed graphite by immersing a natural graphite in acid,
manufacturing a mixed graphite by adding to the formed graphite one or more kinds of thermally conductive fillers selected from a group consisting of artificial graphite, boron nitride and milled pitch based carbon fiber,
forming the obtained mixed graphite into a sheet shape by rolling it, and sandwiching the sheet shaped graphite between sheet bodies.

13. A method of manufacturing the heat radiating material according to claim 4, comprising the steps of;
manufacturing a foamed graphite by immersing a natural graphite in acid,
manufacturing a mixed graphite by adding to the formed graphite one or more kinds of thermally conductive fillers selected from a group consisting of artificial graphite, boron nitride and milled pitch based carbon fiber,
forming the obtained mixed graphite into a sheet shape by rolling it, and sandwiching the sheet shaped graphite between sheet bodies.

14. A method of manufacturing the heat radiating material according to claim 9, comprising the steps of;
manufacturing a foamed graphite by immersing a natural graphite in acid,
manufacturing a mixed graphite by adding to the formed graphite one or more kinds of thermally conductive fillers selected from a group consisting of artificial graphite, boron nitride and milled pitch based carbon fiber,
forming the obtained mixed graphite into a sheet shape by rolling it, and sandwiching the sheet shaped graphite between sheet bodies.

15. A method of manufacturing the heat radiating material according to claim 10, comprising the steps of;
manufacturing a foamed graphite by immersing a natural graphite in acid,
manufacturing a mixed graphite by adding to the formed graphite one or more kinds of thermally conductive fillers selected from a group consisting of artificial graphite, boron nitride and milled pitch based carbon fiber,
forming the obtained mixed graphite into a sheet shape by rolling it, and sandwiching the sheet shaped graphite between sheet bodies.

16. The method according to claim 11, wherein the step of manufacturing a foamed graphite comprises obtaining a foamed graphite by grinding a natural graphite into particles, then immersing it in sulfuric acid, neutralizing and cleaning it, wherein the step of manufacturing a mixed graphite comprises adding a natural graphite to a furnace, foaming it at high temperature, adding into the furnace one or more kinds of thermally conductive fillers selected from a group consisting of artificial graphite, boron nitride and milled pitch based carbon fiber, and mixing them.

17. The method according to claim 12, wherein the step of manufacturing a foamed graphite comprises obtaining a foamed graphite by grinding a natural graphite into particles, then immersing it in sulfuric acid, neutralizing and cleaning it, wherein the step of manufacturing a mixed graphite comprises adding a natural graphite to a furnace, foaming it at high temperature, adding into the furnace one or more kinds of thermally conductive fillers selected from a group consisting of artificial graphite, boron nitride and milled pitch based carbon fiber, and mixing them.

18. The method according to claim 13, wherein the step of manufacturing a foamed graphite comprises obtaining a foamed graphite by grinding a natural graphite into particles, then immersing it in sulfuric acid, neutralizing and cleaning it, wherein the step of manufacturing a mixed graphite comprises adding a natural graphite to a furnace, foaming it at high temperature, adding into the furnace one or more kinds of thermally conductive fillers selected from a group consisting of artificial graphite, boron nitride and milled pitch based carbon fiber, and mixing them.

19. The method according to claim 14, wherein the step of manufacturing a foamed graphite comprises obtaining a foamed graphite by grinding a natural graphite into particles, then immersing it in sulfuric acid, neutralizing and cleaning it, wherein the step of manufacturing a mixed graphite comprises adding a natural graphite to a furnace, foaming it at high temperature, adding into the furnace one or more kinds of thermally conductive fillers selected from a group consisting of artificial graphite, boron nitride and milled pitch based carbon fiber, and mixing them.

20. The method according to claim 15, wherein the step of manufacturing a foamed graphite comprises obtaining a foamed graphite by grinding a natural graphite into particles, then immersing it in sulfuric acid, neutralizing and cleaning it, wherein the step of manufacturing a mixed graphite comprises adding a natural graphite to a furnace, foaming it at high temperature, adding into the furnace one or more kinds of thermally conductive fillers selected from a group consisting of artificial graphite, boron nitride and milled pitch based carbon fiber, and mixing them.
